(19) United States
(12) Patent Application Publication
(10) Pub. No.: US 2013/0342583 A1
(43) Pub. Date: Dec. 26, 2013

(54) DISPLAY DEVICE AND DRIVING METHOD THEREOF

(71) Applicant: SAMSUNG DISPLAY CO., LTD., Yongin-City (KR)

(72) Inventors: Myoung-Chul KIM, Suwon-si (KR); Dong Keon KIM, Busan (KR); Bo-Ram KIM, Seoul (KR); Tae Eun KIM, Asan-si (KR); Seoung Bum PYOUN, Hwaseong-si (KR)

(73) Assignee: SAMSUNG DISPLAY CO., LTD., Yongin-City (KR)

(21) Appl. No.: 13/672,138

(22) Filed: Nov. 8, 2012

(30) Foreign Application Priority Data
Jun. 22, 2012 (KR) 10-2012-0067432

(51) Int. Cl. G09G 5/10; G06F 3/038

(52) U.S. Cl. 345/690; 345/211

(57) ABSTRACT

A display device capable of substantially preventing a bruising phenomenon and a driving method thereof are provided. The display device includes a display panel which displays an image and a signal controller which controls signals for driving the display panel. The signal controller includes a first accurate color capture (“ACC”) unit which performs ACC correction on input image data to generate first correction image data; a second ACC unit which performs the ACC correction on the input image data to generate second correction image data; and an ACC selection unit which selectively applies the input image data to the first ACC unit or the second ACC unit. A maximum gray of the second correction image data is lower than a maximum gray of the first correction image data.

This application claims priority to Korean Patent Application No. 10-2012-0067432, filed on Jun. 22, 2012, and all the benefits accruing therefrom under 35 U.S.C. §119, the content of which in its entirety is herein incorporated by reference.

### BACKGROUND

(a) Field

The invention relates to a display device and a driving method thereof, and more particularly, to a display device capable of substantially preventing a bruising phenomenon and a driving method thereof.

(b) Description of the Related Art

A liquid crystal display, which is one of common types of flat panel displays currently in use, includes two sheets of panels with field generating electrodes such as a pixel electrode and a common electrode, and a liquid crystal layer interposed therebetween. The liquid crystal display generates an electric field in the liquid crystal layer by applying voltage to the field generating electrodes and determines a direction of liquid crystal molecules of the liquid crystal layer according to the generated electric field, thus controlling polarization of incident light so as to display an image.

The liquid crystal displays are implemented in various modes, which include driving a liquid crystal by forming a horizontal electric field. For example, a horizontal field mode liquid crystal display includes an in plane switching (“IPS”) mode liquid crystal display or a plane line switching (“PLS”) mode liquid crystal display. In the horizontal field mode liquid crystal display, the pixel electrode and the common electrode are formed on the same substrate, and the horizontal electric field is formed between the two electrodes to align liquid crystal molecules therebetween.

Recently, a screen-touch type mobile phone or a tablet personal computer (“PC”) is widely used and as a result, a demand for a display device capable of recognizing a touch is increased. However, in the horizontal field mode liquid crystal display, there is a problem in that a bruising phenomenon occurs such that a touch point remains visible even after the touch is removed.

In the horizontal field mode liquid crystal display, in the case where high pixel voltage is applied, liquid crystal molecules may be over-twisted from an end portion of the pixel electrode or the common electrode. In this case, when a touch is generated on a surface of the display device, the over-twisted liquid crystal molecules corresponding to a touch position return to a normal state after the touch. However, the over-twisted liquid crystal molecules corresponding to a non-touch position maintain as over-twisted. Accordingly, a difference in luminance between the touch position and the non-touch position is generated to be shown as the bruising phenomenon.

### SUMMARY

The invention has been made in an effort to provide a display device and a driving method thereof having advantages of substantially preventing a bruising phenomenon.

An aspect of the invention provides a display device, including: a display panel which displays an image; and a signal controller which controls signals which drive the display panel, in which the signal controller includes a first accurate color capture unit which performs accurate color capture correction on input image data and generates first correction image data; a second accurate color capture unit which performs the accurate color capture correction on the input image data and generates second correction image data; and an accurate color capture selection unit which selectively applies the input image data to the first accurate color capture unit or the second accurate color capture unit, wherein a maximum gray of the second correction image data is lower than a maximum gray of the first correction image data.

In an exemplary embodiment, the accurate color capture selection unit may select the first accurate color capture unit during a first period and select the second accurate color capture unit during a second period, and the first period and the second period may each correspond to predetermined time intervals and may alternate repeat.

In an exemplary embodiment, the first period may correspond to a time interval of one second or more, and the second period may correspond to a time interval of one frame or more.

In an exemplary embodiment, the display panel may include a first substrate and a second substrate which face each other; a first field generating electrode and a second field generating electrode which are on the first substrate; and a liquid crystal layer which is between the first substrate and the second substrate, and wherein the liquid crystal layer may be driven by an electric field which is generated between the first field generating electrode and the second field generating electrode.

In an exemplary embodiment, the accurate color capture selection unit may select the first accurate color capture unit when an average gray of the input image data of one frame is lower than a first gray, and select the second accurate color capture unit when the average gray of the input image data of one frame is equal to or higher than the first gray.

In an exemplary embodiment, the input image data may include first color input image data, second color input image data and third color input image data, and the accurate color capture selection unit may select the first accurate color capture unit when all of an average gray of the first color input image data, an average gray of the second color input image data, and an average gray of the third color input image data in one frame are lower than a second gray, and select the second accurate color capture unit when one or more of the average gray of the first color input image data, the average gray of the second color input image data, and the average gray of the third color input image data in one frame are equal to or higher than the second gray.

Another aspect of the invention provides a display device, including: a display panel which displays an image; a signal controller which controls signals which drive the display panel; and a common voltage generator which selectively applies first common voltage or second common voltage to the display panel, in which the common voltage generator includes a first common voltage generator which generates the first common voltage and applies the first common voltage to the display panel; a second common voltage generator which generates the second common voltage and applies the second common voltage to the display panel; and a common voltage controller which selectively applies the first common voltage or the second common voltage to the display panel, and the first common voltage and the second common voltage have different values.

In an exemplary embodiment, the common voltage controller may control the first common voltage generator to apply the first common voltage to the display panel during a first period, and the second common voltage generator to apply the second common voltage to the display panel during a second period, and the first period and the second period may each correspond to predetermined time intervals and may be alternately repeated.

In an exemplary embodiment, the first period may correspond to a time interval of one second or more, and the second period may correspond to a time interval of one frame or more.

In an exemplary embodiment, the display panel may include a first substrate and a second substrate which face each other; a first field generating electrode and a second field generating electrode which are on the first substrate; and a liquid crystal layer which is between the first substrate and the second substrate, and the liquid crystal layer may be driven by an electric field which is generated between the first field generating electrode and the second field generating electrode.

In an exemplary embodiment, the common voltage controller may control the first common voltage generator to apply the first common voltage to the display panel when an average gray of the input image data of one frame is lower than a first gray, and control the second common voltage generator to apply the second common voltage to the display panel when the average gray of the input image data of one frame is equal to or higher than the first gray.

In an exemplary embodiment, the input image data may include first color input image data, second color input image data and third color input image data, and the common voltage controller may control the first common voltage generator to apply the first common voltage to the display panel when all of an average gray of the first color input image data, an average gray of the second color input image data, and an average gray of the third color input image data in one frame are lower than a second gray, and control the second common voltage generator to apply the second common voltage to the display panel when one or more of the average gray of the first color input image data, the average gray of the second color input image data, and the average gray of the third color input image data in one frame are equal to or higher than the second gray.

Yet another aspect of the invention provides a driving method of a display device, the driving method including: generating first correction image data by performing accurate color capture correction on input image data; generating second correction image data by performing accurate color capture correction on the input image data; and selectively outputting the first correction image data and the second correction image data, in which a maximum gray of the second correction image data is lower than a maximum gray of the first correction image data.

In an exemplary embodiment, the first correction image data may be generated and outputted during a first period, and the second correction image data may be generated and outputted during a second period, and the first period and the second period may each correspond to predetermined time intervals and may be alternately repeated.

In an exemplary embodiment, the first correction image data may be generated and outputted when an average gray of the input image data of one frame is lower than a first gray, and the second correction image data may be generated and outputted when the average gray of the input image data of one frame is equal to or higher than the first gray.

In an exemplary embodiment, the input image data may include first color input image data, second color input image data and third color input image data, and the first correction image data may be generated and outputted when all of an average gray of the first color input image data, an average gray of the second color input image data, and an average gray of the third color input image data in one frame are lower than a second gray, and the second correction image data may be generated and outputted when one or more of the average gray of the first color input image data, the average gray of the second color input image data, and the average gray of the third color input image data in one frame are equal to or higher than the second gray.

Still another aspect of the invention provides a driving method of a display device, the driving method including: generating first common voltage; generating second common voltage; and selectively applying the first common voltage and the second common voltage to a display panel of the display device, and the first common voltage and the second common voltage have different values.

In an exemplary embodiment, the first common voltage may be applied to the display panel during a first period, and the second common voltage may be applied to the display panel during a second period, and the first period and the second period may each correspond to predetermined time intervals and may be alternately repeated.

In an exemplary embodiment, the first common voltage may be applied to the display panel when an average gray of the input image data of one frame is lower than a first gray, and the second common voltage may be applied to the display panel when the average gray of the input image data of one frame is equal to or higher than the first gray.

In an exemplary embodiment, the input image data may include first color input image data, second color input image data and third color input image data, and the first common voltage may be applied to the display panel when all of an average gray of the first color input image data, an average gray of the second color input image data, and an average gray of the third color input image data in one frame are lower than a second gray, and the second common voltage may be applied to the display panel when one or more of the average gray of the first color input image data, the average gray of the second color input image data, and the average gray of the third color input image data in one frame are equal to or higher than the second gray.

According to exemplary embodiments of the invention, an accurate color capture correction is performed periodically or when a predetermined condition is satisfied, so as to lower a maximum gray, such that it is possible to substantially prevent a bruising phenomenon.

Further, according to exemplary embodiments of the invention, the common voltage is changed periodically or when a predetermined condition is satisfied, such that it is possible to substantially prevent a bruising phenomenon.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a block diagram illustrating an exemplary embodiment of a display device according to the invention;

FIG. 2 is a plan view illustrating an exemplary embodiment of a thin film transistor array panel having a pixel in a display area thereof according to the invention;

FIG. 3 is a cross-sectional view illustrating the thin film transistor array panel of FIG. 2 taken along line III-III;

FIG. 4 is a block diagram illustrating an exemplary embodiment of a signal controller of the display device of FIG. 1 according to the invention;

FIG. 5 is a driving timing diagram of the display device of FIG. 1 according to the invention;

FIG. 6 is a block diagram illustrating another exemplary embodiment of a display device according to the invention;

FIG. 7 is a block diagram illustrating an exemplary embodiment of a common voltage generator of the display device of FIG. 6 according to the invention; and

FIG. 8 is a driving timing diagram of the display device of FIG. 6 according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

First, a display device according to an exemplary embodiment of the invention will be described below with reference to the accompanying drawings.

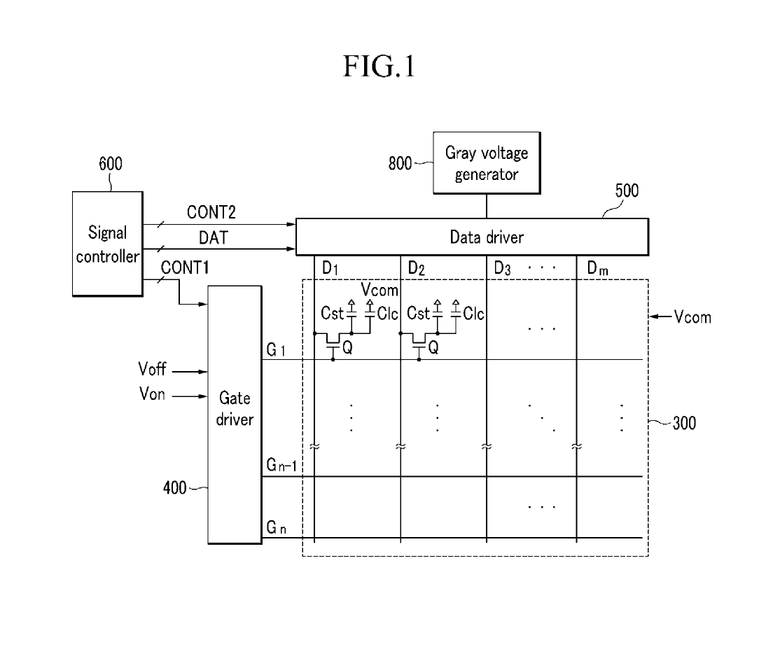

FIG. 1 is a block diagram illustrating an exemplary embodiment of a display device according to the invention.

As shown in FIG. 1, the display device according to an exemplary embodiment of the invention includes a display panel 300 which displays an image and a signal controller 600 which controls signals for driving the display panel 300.

The display panel 300 includes a plurality of gate lines G1-Gn and a plurality of data lines D1-Dm, the plurality of gate lines G1-Gn extends in a horizontal direction, and the plurality of data lines D1-Dm extends in a vertical direction while substantially crossing the plurality of gate lines G1-Gn.

One gate line and one data line are each connected with one pixel, which includes a switching element Q connected with the gate line and the data line. A control terminal of the switching element Q is connected with the gate line, an input terminal thereof is connected with the data line, and an output terminal thereof is connected with a liquid crystal capacitor Clc and a storage capacitor Cst.

One terminal of the liquid crystal capacitor Clc is connected with the output terminal of the switching element Q, and the other terminal is connected with a common electrode to which common voltage Vcom is applied.

A pixel electrode (not shown) connected with the switching element Q is formed in the pixel.

An electric field is formed between the pixel electrode and the common electrode by data voltage applied to the pixel electrode through the data lines D1-Dm and the common voltage Vcom applied to the common electrode. In this case, the pixel electrode and the common electrode may be formed on the same substrate, and the electric field formed between the pixel electrode and the common electrode may be a horizontal electric field.

The display panel 300 of FIG. 1 is shown as a liquid crystal display panel, however, it should be noted that the display panel 300 to which the invention may be applied may use various display panels such as, for example, an organic light emitting display panel, an electrophoretic display panel, and a plasma display panel in addition to the liquid crystal display panel. Further, although the horizontal field mode liquid crystal display panel is described above, the invention is not limited thereto and may also be applied to a vertical field mode liquid crystal display panel.

The signal controller 600 processes input image data received from an outside and a control signal thereof including, for example, a vertical synchronization signal Vsync (not shown), a horizontal synchronizing signal Hsync (not shown), a main clock signal MCLK (not shown), and a data enable signal DE (not shown) and generates and outputs image data DAT, a gate control signal CONT1 and a data control signal CONT2.

The gate control signal CONT1 includes, for example, a vertical synchronization start signal STV which instructs an output start of a gate-on pulse (a signal high period of a gate signal GS) and a gate clock signal CPV which controls an output timing of the gate-on pulse.

The data control signal CONT2 includes, for example, a horizontal synchronization start signal STH which instructs an input start of the image data DAT and a load signal TP which instructs application of corresponding data voltage to the data lines D1-Dm.

The display device according to an exemplary embodiment of the invention may further include a gate driver 400 which drives the gate lines G1-Gn and a data driver 500 which drives the data lines D1-Dm.

The plurality of gate lines G1-Gn of the display panel 300 is connected to the gate driver 400, and the gate driver 400 alternately applies gate-on voltage Von and gate-off voltage Voff to the gate lines G1-Gn based on the gate control signal CONT1 applied from the signal controller 600.

The display panel 300 may be formed of two sheets of substrates which are adhered facing each other, and the gate driver 400 may be attached to one edge portion of the display panel 300. Further, the gate driver 400 may be mounted on the display panel 300 together with the gate lines G1-Gn, the data lines D1-Dm and the switching element Q. That is, the gate driver 400 may be formed in a process of forming the gate lines G1-Gn, the data lines D1-Dm and the switching element Q.

The plurality of data lines D1-Dm of the display panel 300 is connected with the data driver 500, and the data driver 500 receives the data control signal CONT2 and the image data DAT from the signal controller 600. The data driver 500 converts the image data DAT into data voltage by using gray voltage generated from a gray voltage generator 800 and transfers the data voltage to the data lines D1-Dm.

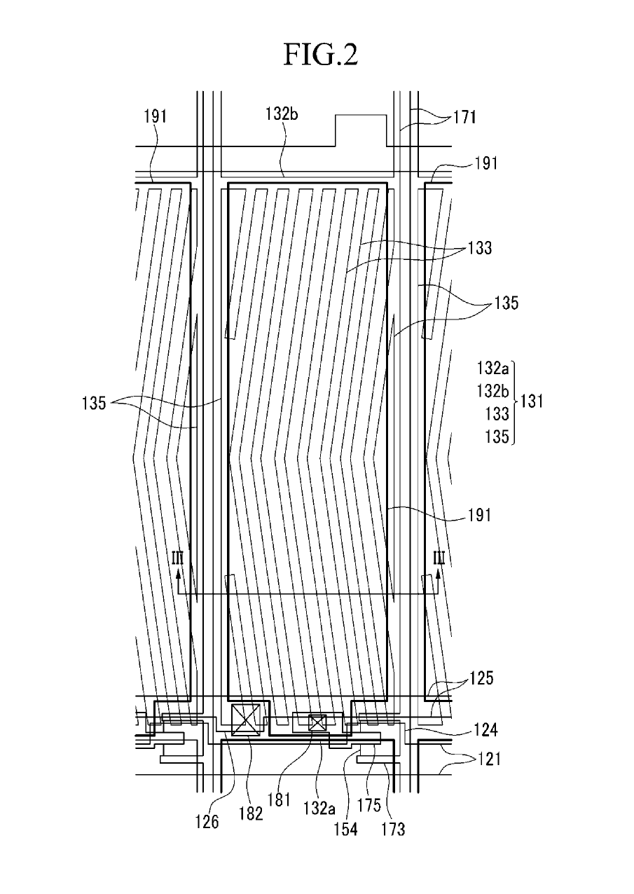

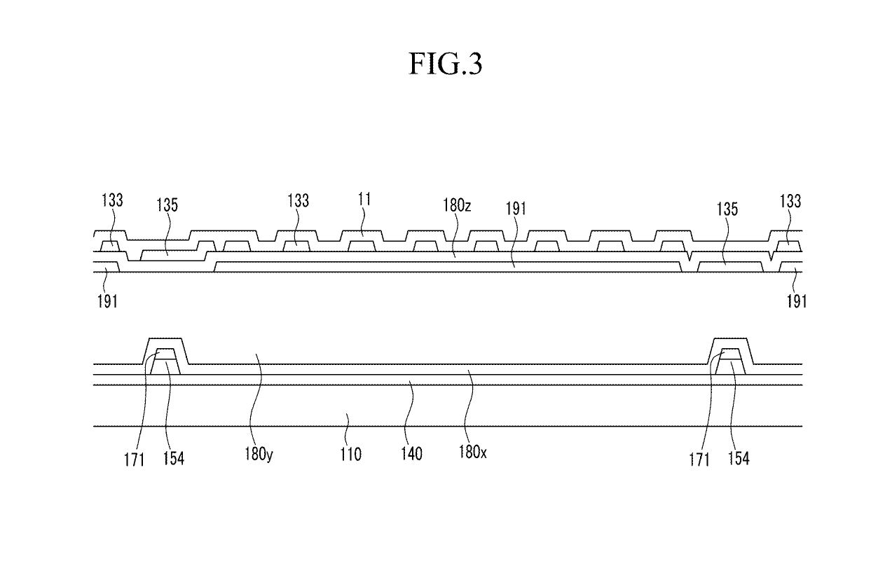

Next, a display panel of the display device according to an exemplary embodiment of the invention will be described below with reference to FIGS. 2 and 3.

FIG. 2 is a plan view illustrating an exemplary embodiment of a thin film transistor array panel having a pixel in a display area thereof according to the invention, and FIG. 3 is a cross-sectional view illustrating the thin film transistor array panel of FIG. 2 taken along line III-III.

Referring to FIGS. 2 and 3, a plurality of gate conductors including a plurality of gate lines 121 and a plurality of common voltage lines 125 is formed on a first substrate 110.

The gate line 121 transfers a gate signal and extends in a horizontal direction in substantial part thereof. Each gate line 121 includes a plurality of gate electrodes 124.

The common voltage line 125 may transfer predetermined voltage such as the common voltage Vcom, extend in a horizontal direction in substantial part thereof, and be substantially parallel to the gate line 121. Each common voltage line 125 may include a plurality of extensions 126.

A gate insulating layer 140 is formed on the gate conductors 121 and 125. The gate insulating layer 140 may comprise an inorganic insulator such as, for example, silicon nitride (SiNx) or silicon oxide (SiOx).

A plurality of semiconductors 154 is formed on the gate insulating layer 140. An ohmic contact layer (not shown) is disposed on the semiconductor 154. In an alternatively embodiment, the ohmic contact layer may be omitted.

A data conductor including a plurality of data lines 171 and a plurality of drain electrodes 175 is formed on the ohmic contact layer.

The data line 171 transfers a data signal and extends substantially in a vertical direction, in substantial part thereof, to cross the gate line 121 and the common voltage line 125. Each data line 171 includes a plurality of source electrodes 173 which extends toward the gate electrodes 124.

The drain electrode 175 includes one bar-type end portion, which face the source electrode 173 relative to the gate electrode 124, and the other end portion having a wide area.

The gate electrode 124, the source electrode 173 and the drain electrode 175, together with the semiconductor 154, form a thin film transistor (“TFT”) which is the switching element Q. The semiconductor 154 may have substantially the same planar form as the data line 171 and the drain electrode 175, except for a channel part of the thin film transistor.

A first passivation layer 180x is formed on the data conductors 171 and 175 and the exposed semiconductor 154, and the first passivation layer 180x may comprise, for example, an organic insulating material or an inorganic insulating material.

A second passivation layer 180y is positioned on the first passivation layer 180x. The second passivation layer 180y includes an organic material, covers the data line 171, and may be formed over the entire first substrate 110. In an exemplary embodiment of the invention, the second passivation layer 180y may have a substantially flat surface.

A contact hole 181 which exposes a part of the drain electrode 175 is formed in the first passivation layer 180x and the second passivation layer 180y.

A plurality of pixel electrodes 191 is positioned on the second passivation layer 180y. The pixel electrodes 191 may have a planar shape which occupies a substantial portion of a region surrounded by the gate line 121 and the data line 171. The pixel electrodes 191 may be of a polygon shape having sides which are respectfully substantially parallel to the gate line 121 and the data line 171, and both edges of a lower portion of the pixel electrode 191 located proximate to the thin film transistor may be chamfered. However, the shape of the pixel electrode 191 of the invention is not limited thereto. The pixel electrode 191 may comprise a transparent conductive material such as indium tin oxide (“ITO”) or indium zinc oxide (“IZO”). The pixel electrode 191 receives data voltage from the drain electrode 175 through the contact hole 181.

A third passivation layer 180z is formed on the pixel electrode 191. The third passivation layer 180z may comprise, for example, an inorganic insulator or an organic insulator. A plurality of contact holes 182 which each expose a part of the common voltage line 125 (for example, a part of the extension 126 of the common voltage line 125) is formed in the third passivation layer 180z, the second passivation layer 180y, the first passivation layer 180x and the gate insulating layer 140.

A plurality of common electrodes 131 is formed on the third passivation layer 180z. The common electrode 131 may comprise a transparent conductive material such as ITO or IZO.

Each common electrode 131 includes a pair of vertical portions, defined by line 135, covering the data line 171, a plurality of branch electrodes, defined by line 133, which is positioned between the two vertical portions and separated from one another, and a lower horizontal portion defined by line 132a and an upper horizontal portion, defined by line 132b, which connect end portions of the plurality of branch electrodes. The vertical portion extends substantially parallel to the data line 171 and covers the data line 171. The lower and upper horizontal portions each extend substantially parallel to the data line 121. The plurality of branch electrodes are substantially parallel to one another and form oblique angles with an extension direction of the gate line 121, and the oblique angle may be 45 degrees or more. Upper and lower portion of the branch electrodes may substantially have inversion symmetry with respect to a virtual horizontal center line thereof. The adjacent common electrodes share the vertical portion therebetween and are connected to each other. The common electrode 131 receives predetermined voltage such as the common voltage Vcom from the common voltage line 125 through the contact hole 182. The common electrode 131 according to an exemplary embodiment of the invention is overlapped with the pixel electrode 191. Particularly, at least two branch electrodes, which are adjacent to one another in the common electrode 131, are overlapped with one pixel electrode 191 which has a planar shape.

Although not shown, a second substrate is formed to face the first substrate 110, and a liquid crystal layer is between the first substrate 110 and the second substrate. As the data voltage and the common voltage Vcom are applied to the pixel electrode 191 and the common electrode 131, respectively, the liquid crystal layer is driven by a horizontal electric field which is generated between the pixel electrode 191 and the common electrode 131.

The display device according to an exemplary embodiment of the invention described above is a plane line switching (“PLS”) mode liquid crystal display, however, the display device of the invention is not limited thereto. In alternative exemplary embodiments, horizontal field mode liquid crystal displays such as an in plane switching (“IPS”) mode liquid crystal display and a fringe field switching (“FFS”) mode liquid crystal display may be used.

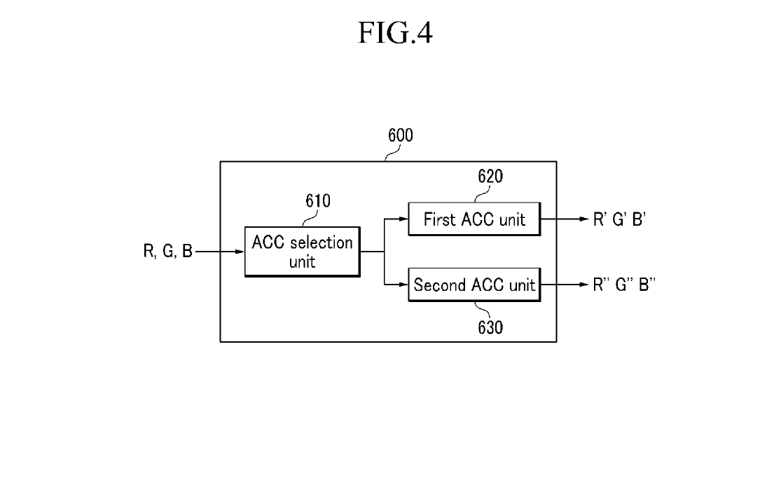

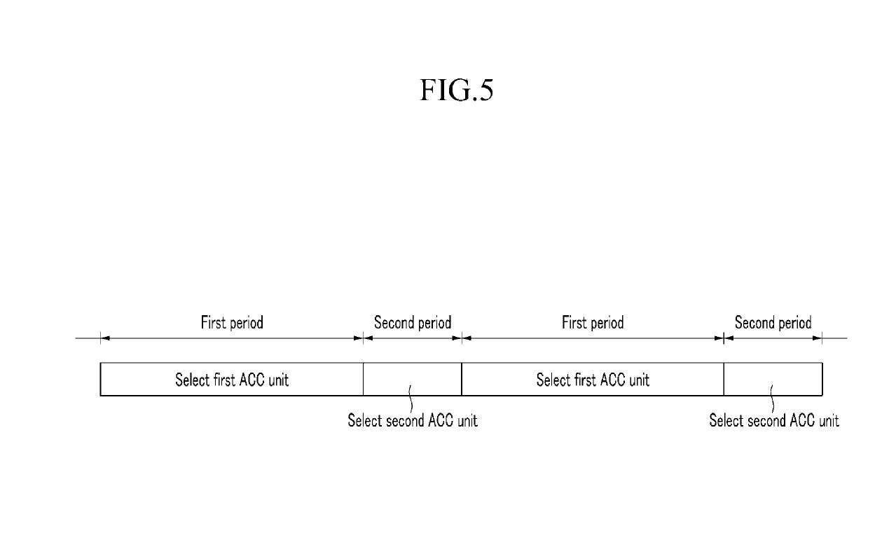

Next, a signal controller of the display device according to an exemplary embodiment of the invention will be described with reference to FIGS. 4 and 5.

FIG. 4 is a block diagram illustrating an exemplary embodiment of the signal controller of the display device of FIG. 1 according to the invention, and FIG. 5 is a driving timing diagram of the display device of FIG. 1 according to the invention.

Input image data R, G and B are applied to the signal controller 600 from an outside. The input image data R, G and B include information on grays of each pixel which displays a screen.

The signal controller 600 includes a first accurate color capture (“ACC”) unit 620 which performs ACC correction on the input image data R, G and B to generate first correction image data R′, G′ and B′, a second ACC unit 630 which performs ACC correction on the input image data R, G and B to generate second correction image data R″, G″ and B″, and an ACC selection unit 610 which selectively applies the input image data R, G and B to the first ACC unit 620 or the second ACC unit 630.

The first ACC unit 620 may use a lookup table to perform the ACC correction. In an exemplary embodiment, as shown in Table 1, the first ACC unit 620 may generate the first correction image data R′, G′ and B′, which represent white.

Table 1 is a table illustrating exemplary first correction image data which are corrected by the first ACC unit 620.

TABLE 1

| White gray | Red gray | Green gray | Blue gray |
|---|---|---|---|
| (8 bits) | (10 bits) | (10 bits) | (10 bits) |
| 241 | 947 | 949 | 950 |
| 242 | 951 | 953 | 955 |
| 243 | 956 | 958 | 959 |
| 244 | 960 | 962 | 963 |
| 245 | 965 | 966 | 967 |
| 246 | 969 | 970 | 971 |
| 247 | 976 | 974 | 975 |
| 248 | 977 | 979 | 979 |
| 249 | 982 | 983 | 983 |
| 250 | 986 | 987 | 987 |
| 251 | 990 | 991 | 991 |
| 252 | 994 | 994 | 994 |
| 253 | 997 | 998 | 998 |
| 254 | 1001 | 1001 | 1001 |
| 255 | 1008 | 1008 | 1008 |

In an exemplary embodiment, grays represented in 8 bits may have 256 grays from 0 gray to 255 gray. Further, grays represented in 10 bits may have 1,024 grays from 0 gray to 1,023 gray.

Here, in order to express a white screen corresponding to 247 gray in an 8-bit gray scale, the first ACC unit 620 may be driven in the 10-bit gray scale so that a red subpixel displays 976 gray, a green subpixel displays 974 gray, and a blue subpixel displays 975 gray. Further, in order to express a white screen corresponding to 251 gray in the 8-bit gray scale, the first ACC unit 620 may be driven in the 10-bit gray scale so that the red subpixel displays 990 gray, the green subpixel displays 991 gray, and the blue subpixel displays 991 gray.

That is, ratios among gray levels of red, green and blue for displaying white may be varied depending on a gray scale. Here, in order to display white to the brightest level, the red, green and blue subpixels may be driven with values which are close to maximum grays.

In a normally black mode display device, in order for the red, green and blue subpixels to represent the maximum grays, each subpixel may be driven by maximum voltage.

The second ACC unit 630 may also use a lookup table similar to that of the first ACC unit 620 to perform the ACC correction.

Table 2 is a table illustrating exemplary second correction image data which are corrected by the second ACC unit 630.

TABLE 2

| White gray | Red gray | Green gray | Blue gray |
|---|---|---|---|
| (8 bits) | (10 bits) | (10 bits) | (10 bits) |
| 241 | 916 | 918 | 919 |
| 242 | 921 | 922 | 923 |
| 243 | 925 | 926 | 927 |
| 244 | 929 | 931 | 931 |
| 245 | 934 | 935 | 935 |
| 246 | 938 | 939 | 940 |
| 247 | 942 | 943 | 944 |
| 248 | 946 | 947 | 948 |
| 249 | 951 | 951 | 952 |
| 250 | 955 | 956 | 956 |
| 251 | 959 | 960 | 960 |
| 252 | 963 | 964 | 964 |
| 253 | 968 | 968 | 968 |
| 254 | 972 | 972 | 972 |
| 255 | 976 | 976 | 976 |

Here, in order to express a white screen corresponding to 247 gray in the 8-bit gray scale, the second ACC 630 unit may be driven in the 10-bit gray scale so that the red subpixel displays 942 gray, the green subpixel displays 943 gray, and the blue subpixel displays 944 gray. Further, in order to express a white screen corresponding to 251 gray in the 8-bit gray scale, the second ACC 630 unit may be driven in the 10-bit gray scale so that the red subpixel displays 959 gray, the green subpixel displays 960 gray, and the blue subpixel displays 960 gray.

A maximum gray of the second correction image data R″, G″ and B″ corrected by the second ACC unit 630 has a lower value than the maximum gray of the first correction image data R′, G′ and B′. That is, in order to express white corresponding to 255 gray which is a maximum gray in the 8-bit gray scale, the first ACC unit 620 generates the first correction image data R′, G′ and B′ so that the red subpixel represents 1,008 gray, the green subpixel represents 1,008 gray, and the blue subpixel represents 1,008 gray. On the other hand, in order to express white of 255 gray which is the maximum gray in the 8-bit gray scale, the second ACC unit 630 generates the second correction image data R″, G″ and B″ so that the red subpixel represents 976 gray, the green subpixel represents 976 gray, and the blue subpixel represents 976 gray.

As the grays of the red, green and blue subpixels for representing the maximum gray of the second correction image data R″, G″ and B″ are lowered compared with those of the first correction image data R′, G′ and B′, the grays for the red, green and blue subpixels for representing grays less than 255 gray of the second correction image data R″, G″ and B″ are also lowered compared with those of the first correction image data R′, G′ and B′.

As shown in FIG. 5, the ACC selection unit 610 selects the first ACC unit 620 during a first period to apply the input image data R, G and B to the first ACC unit 620. Also, the ACC selection unit 610 selects the second ACC unit 630 during a second period to apply the input image data R, G and B to the second ACC unit 630.

The first period and the second period are each predetermined time intervals and may be alternately repeated. That is, the ACC selection unit 610 selects the first ACC unit 620 and the second ACC unit 630 at a predetermined period.

In this case, the first period may be 1 second or more, and the second period may be a time period of one frame or more. However, intervals of the first period and the second period are not limited thereto and may be variously set.

In an exemplary embodiment, the first period may be set to 5 seconds, and the second period may be set to one frame. In a display device driven by 60 hertz (Hz), one frame represents a time period of 1/60 second.

Hereinafter, a driving method of a display device according to an exemplary embodiment of the invention will be described.

When the input image data R, G and B are inputted to the ACC selection unit 610 of the signal controller 600, the ACC selection unit 610 selects the first ACC unit 620 during the first period. When the ACC selection unit 610 applies the input image data R, G and B to the first ACC unit 620, the first ACC unit 620 performs the ACC correction on the input image data R, G and B to generate and output the first correction image data R′, G′ and B′. The first correction image data R′, G′ and B′ are applied to the data driver 500, and the data driver 500 applies data voltage corresponding to the first correction image data R′, G′ and B′ to the data lines D1-Dm of the display panel 300, thereby displaying an image.

Next, when the second period starts, the ACC selection unit 610 selects the second ACC unit 630. When the ACC selection unit 610 applies the input image data R, G and B to the second ACC unit 630, the second ACC unit 630 performs the ACC correction on the input image data R, G and B to generate and output the second correction image data R″, G″ and B″. The second correction image data R″, G″ and B″ are applied to the data driver 500, and the data driver 500 applies data voltage corresponding to the second correction image data R″, G″ and B″ to the data lines D1-Dm of the display panel 300, thereby displaying an image.

Next, the first period starts again and the ACC selection unit 610 selects the first ACC unit 620 so that the first ACC unit 620 generates and outputs the first correction image data R′, G′ and B′.

In an exemplary embodiment, in the case where the first period is set to 5 seconds and the second period is set to one frame, when the same input image data R, G and B are inputted, luminance of the screen is lowered when the first period of 5 seconds elapses and returns to an original level when the second period of one frame elapses. A bruising phenomenon occurs when high voltage is applied to the pixel and disappears when the voltage is temporarily lowered. In order to substantially prevent the bruising phenomenon, if power supply voltage is lowered, the luminance of the entire screen is decreased. However in an exemplary embodiment of the invention, the second period in which the display device is driven with a lower data voltage is set to be shorter than the first period such that the problem may be substantially prevented. In order for a decrease in the luminance to be invisible, a length of the second period may be set to a time period of, for example, one frame to 60 frames.

In the display device according to an exemplary embodiment of the invention, the ACC selection unit 610 periodically selects the first ACC unit 620 or the second ACC unit 630, however the invention is not limited thereto and the ACC selection unit 610 may aperiodically select the first ACC unit 620 or the second ACC unit 630.

The ACC selection unit 610 may receive input image data R, G and B of one frame and calculate an average gray thereof. Next, the average gray of the input image data R, G and B of one frame is compared with a first gray. The first gray may be set to be equal to or lower than a gray in which the bruising may occur.

In the case where the average gray of the input image data R, G and B of one frame is lower than the first gray, the ACC selection unit 610 may select the first ACC unit 620, and in the case where the average gray of input image data R, G and B of one frame is equal to or higher than the first gray, the ACC selection unit 610 may select the second ACC unit 630.

That is, it is determined whether the gray of the corresponding frame is high enough to cause the bruising, and when it is determined that the bruising may occur, the display device may be driven at lower luminance.

Further, the bruising may occur not only when an average gray of entire image data is high but also when image data of any one of red, green and blue is high.

Thus, the ACC selection unit 610 may receive the input image data R, G and B of one frame, which are divided into red input image data, green input image data and blue input image data, and calculate an average gray of each data. Next, the average gray of the red input image data, the average gray of the green input image data, and the average gray of the blue input image data in one frame are compared with a second gray. The second gray may be set to be equal to or lower than a gray in which the bruising may occur.

In the case where all of the average gray of the red input image data, the average gray of the green input image data, and the average gray of the blue input image data in one frame are lower than the second gray, the ACC selection unit 610 may select the first ACC unit 620, and in the case where one or more of the average gray of the red input image data, the average gray of the green input image data, and the average gray of the blue input image data in one frame are equal to or higher than the second gray, the ACC selection unit 610 may select the second ACC unit 630.

In the above, it is described that one pixel comprises the red subpixel, the green subpixel and the blue subpixel, however, the invention is not limited thereto. In other words, a first color subpixel, a second color subpixel and a third color subpixel which configure one pixel may display colors other than red, green and blue. Further, an additional subpixel such as a fourth color subpixel may be further used.

Next, a display device according to another exemplary embodiment of the invention will be described below with reference to the accompanying drawings.

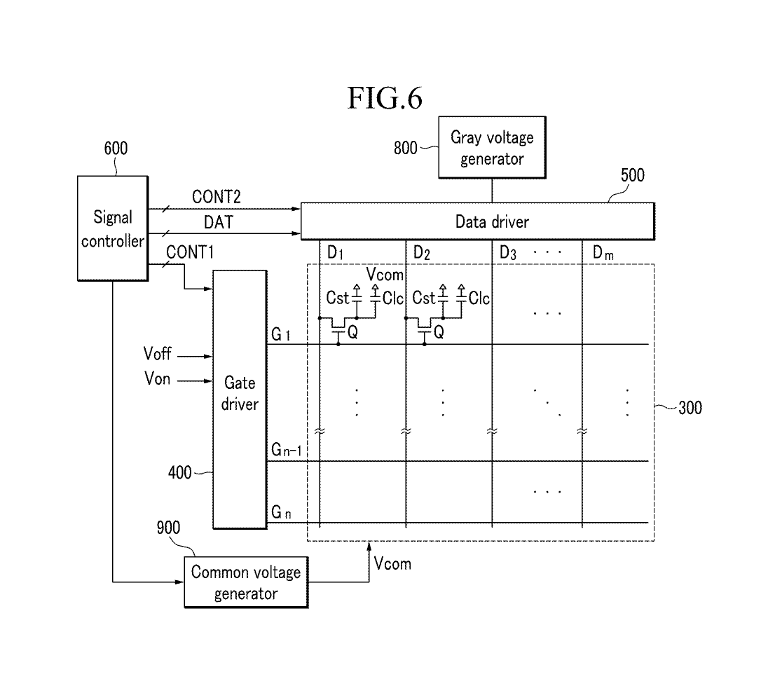

FIG. 6 is a block diagram illustrating another exemplary embodiment of a display device according to the invention.

The display device according to another exemplary embodiment of the invention has a configuration similar to that of the display device shown in FIG. 1, and thus, description of the same elements is omitted and only difference will be described below.

Similar to the display device shown in FIG. 1, the display device according to another exemplary embodiment of the invention includes a display panel 300 which displays an image and a signal controller 600 which controls signals for driving the display panel 300, as shown in FIG. 6.

Also, the display device according to another exemplary embodiment of the invention further includes a common voltage generator 900 which generates common voltage Vcom to apply the common voltage Vcom to the display panel 300.

The common voltage Vcom includes first common voltage and second common voltage, and the common voltage generator 900 selectively applies the first common voltage or the second common voltage. The first common voltage and the second common voltage have different voltage values.

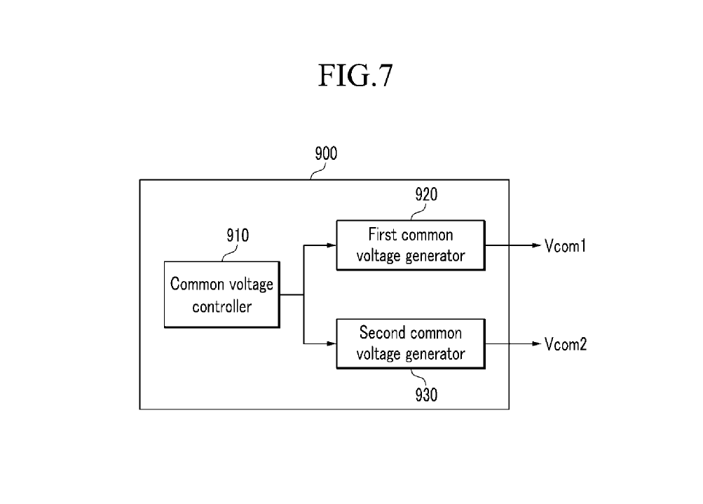

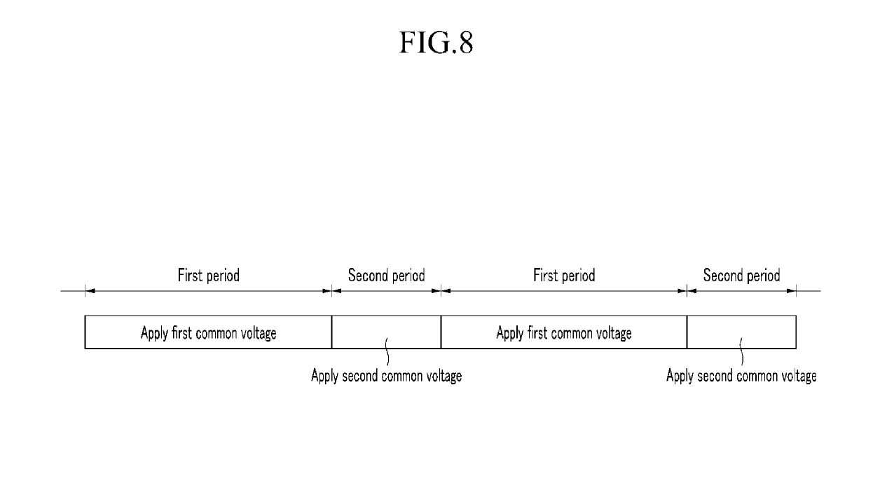

Hereinafter, the common voltage generator 900 of the display device according to another exemplary embodiment of the invention will be described with reference to FIGS. 7 and 8.

FIG. 7 is a block diagram illustrating an exemplary embodiment of a common voltage generator of the display device of FIG. 6 according to the invention, and FIG. 8 is a driving timing diagram of the display device of FIG. 6 according to the invention.

The common voltage generator 900 includes a first common voltage generator 920 which generates first common voltage Vcom1 to apply the first common voltage Vcom1 to the display panel 300, a second common voltage generator 930 which generates second common voltage Vcom2 to apply the second common voltage Vcom2 to the display panel 300, and a common voltage controller 910 which controls the first common voltage generator 920 and the second common voltage generator 930.

The first common voltage generator 920 and the second common voltage generator 930 generate the first common voltage Vcom1 and the second common voltage Vcom2 which are different from each other, respectively. In the case where power supply voltage is 7.6 volts (V), the first common voltage Vcom1 is 3.8 V, and the second common voltage Vcom2 may be set to a lower value than the first common voltage Vcom1. In an exemplary embodiment, the second common voltage Vcom2 may be 3.5 V.

Positive data voltage corresponding to a maximum gray may be 7.6 V, and negative data voltage corresponding to the maximum gray may be 0 V. In this case, when the first common voltage Vcom1 is applied to the display panel 300, a strong electric field is formed in a pixel which represents the maximum gray. When the second common voltage Vcom2 is applied to the display panel 300, an electric field, which is weaker than the electric field formed by the first common voltage Vcom1, is formed in the pixel which represents the positive maximum gray.

As shown in FIG. 8, the common voltage controller 910 controls the first common voltage generator 920 to generate the first common voltage Vcom1 and apply the first common voltage Vcom1 to the display panel 300 during a first period. Next, the common voltage controller 910 controls the second common voltage generator 930 to generate the second common voltage Vcom2 and apply the second common voltage Vcom2 to the display panel 300 during a second period.

The first period and the second period are predetermined time intervals and may be alternately repeated. That is, the common voltage controller 910 selectively applies the first common voltage Vcom1 or the second common voltage Vcom2 to the display panel 300 at a predetermined period.

Here, the first period may be 1 second or more, and the second period may be a time period of one frame or more. However, intervals of the first period and second periods are not limited thereto and may be variously set.

In an exemplary embodiment, the first period may be set to 5 seconds, and the second period may be set to one frame. In the display device driven by 60 hertz (Hz), one frame represents a time period of 1/60 second.

Hereinafter, a driving method of the display device according to another exemplary embodiment of the invention will be described.

The common voltage controller 910 controls the first common voltage generator 920 to generate the first common voltage Vcom1 and apply the first common voltage Vcom1 to the display panel 300 during the first period.

Next, when the second period starts, the common voltage controller 910 controls the second common voltage generator 930 to generate the second common voltage Vcom2 and apply the second common voltage Vcom2 to the display panel 300 during the second period. Since the first common voltage Vcom1 and the second common voltage Vcom2 are different from each other, in the case where the same data voltage is applied to the data lines D1-Dm, the intensity of the electric field which is formed in a corresponding pixel varies in the first period and the second period.

Next, the first period starts again, and the common voltage controller 910 controls the first common voltage generator 920 to generate the first common voltage Vcom1 and apply the first common voltage Vcom1 to the display panel 300.

In an exemplary embodiment, in the case where the first period is set to 5 seconds and the second period is set to two frames, when the same data voltage is applied to the data lines D1-Dm, luminance of the screen is changed when the first period of 5 seconds elapses and returns to an original level when the second period of two frames elapses. The bruising phenomenon occurs when a strong electric field is formed in the pixel, and thus, the bruising phenomenon disappears when the intensity of the electric field is temporarily lowered.

In the case where the second common voltage Vcom2 is set to a lower value than the first common voltage Vcom1, when positive data voltage corresponding to the maximum gray is applied to the corresponding pixel, the intensity of the electric field may be lowered and the bruising phenomenon disappears. On the other hand, when negative data voltage corresponding to the maximum gray is applied to the corresponding pixel, the intensity of the electric field is increased. However, when the second period is set to two frames or more and a polarity inversion occurs in the next frame, the intensity of the electric field may be lowered in the next frame and the bruising phenomenon disappears accordingly.

In the case where the second common voltage Vcom2 is set to a higher value than the first common voltage Vcom1, when negative data voltage corresponding to the maximum gray is applied to the corresponding pixel, the intensity of the electric field may be lowered and the bruising phenomenon disappears. On the other hand, when positive data voltage corresponding to the maximum gray is applied to the corresponding pixel, the intensity of the electric field is increased. However, when the second period is set to two frames or more and a polarity inversion occurs in the next frame, the intensity of the electric field may be lowered in the next frame and the bruising phenomenon disappears accordingly.

As described above, in a driving method of the display device according to another exemplary embodiment of the invention, it is preferable that the second period is set to two frames or more, and the polarity is inverted every frame.

In the display device according to another exemplary embodiment of the invention, it is described that the common voltage controller 910 periodically controls the first common voltage Vcom1 or the second common voltage Vcom2 to be applied to the display panel 300, however, the invention is not limited thereto and the common voltage controller 910 may aperiodically control the first common voltage Vcom1 or the second common voltage Vcom2.

The common voltage controller 910 may receive input image data R, G and B of one frame and calculate an average gray thereof. Next, the average gray of the input image data R, G and B of one frame is compared with a first gray. The first gray may be set to be equal to or lower than a gray in which the bruising may occur.

In the case where the average gray of the input image data R, G and B of one frame is lower than the first gray, the common voltage controller 910 controls the first common voltage Vcom1 to be applied to the display panel 300, and in the case where the average gray of input image data R, G and B of one frame is equal to or higher than the first gray, the common voltage controller 910 controls the second common voltage Vcom2 to be applied to the display panel 300.

That is, it is determined whether the gray of the corresponding frame is high enough to cause the bruising, and when it is determined that the bruising may occur, the display device may be driven at lower luminance.

Further, the bruising may occur not only when an average gray of entire image data is high but also when image data of any one of red, green and blue is high.

Thus, the common voltage controller 910 may receive the input image data R, G and B of one frame, which are divided into red input image data, green input image data and blue input image data, and calculate an average gray of each data. Next, the average gray of the red input image data, the average gray of the green input image data, and the average gray of the blue input image data in one frame are compared with a second gray. The second gray may be set to be equal to or lower than a gray in which the bruising may occur.

In the case where all of the average gray of the red input image data, the average gray of the green input image data, and the average gray of the blue input image data in one frame are lower than the second gray, the common voltage controller 910 controls the first common voltage Vcom1 to be applied to the display panel 300, and in the case where one or more of the average gray of the red input image data, the average gray of the green input image data, and the average gray of the blue input image data in one frame are equal to or higher than the second gray, the common voltage controller 910 controls the second common voltage Vcom2 to be applied to the display panel 300.

In the above, it is described that one pixel comprises the red subpixel, the green subpixel and the blue subpixel, however, the invention is not limited thereto. In other words, a first color subpixel, a second color subpixel and a third color subpixel which configure one pixel may display colors other than red, green and blue. Further, an additional subpixel such as a fourth color subpixel may be further used.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device comprising:
a display panel which displays an image; and
a signal controller which controls signals which drive the display panel,
wherein the signal controller includes:
a first accurate color capture unit which performs accurate color capture correction on input image data and generates first correction image data;
a second accurate color capture unit which performs the accurate color capture correction on the input image data and generates second correction image data; and
an accurate color capture selection unit which selectively applies the input image data to the first accurate color capture unit or the second accurate color capture unit,
wherein a maximum gray of the second correction image data is lower than a maximum gray of the first correction image data.

2. The display device of claim 1, wherein
the accurate color capture selection unit selects the first accurate color capture unit during a first period and selects the second accurate color capture unit during a second period,
the first period and the second period each correspond to predetermined time intervals, and
the first period and the second period alternately repeat.

3. The display device of claim 2, wherein
the first period corresponds to a time interval of one second or more, and
the second period corresponds to a time interval of one frame or more.

4. The display device of claim 1, wherein
the display panel includes:
a first substrate and a second substrate which face each other;
a first field generating electrode and a second field generating electrode which are on the first substrate; and
a liquid crystal layer which is between the first substrate and the second substrate,
wherein the liquid crystal layer is driven by an electric field which is generated between the first field generating electrode and the second field generating electrode.

5. The display device of claim 1, wherein
the accurate color capture selection unit
selects the first accurate color capture unit when an average gray of the input image data of one frame is lower than a first gray, and
selects the second accurate color capture unit when the average gray of the input image data of one frame is equal to or higher than the first gray.

6. The display device of claim 1, wherein
the input image data includes first color input image data, second color input image data and third color input image data, and
the accurate color capture selection unit
selects the first accurate color capture unit when all of an average gray of the first color input image data, an average gray of the second color input image data, and an average gray of the third color input image data in one frame are lower than a second gray, and
selects the second accurate color capture unit when one or more of the average gray of the first color input image data, the average gray of the second color input image data, and the average gray of the third color input image data in one frame are equal to or higher than the second gray.

7. A display device comprising:
a display panel which displays an image;
a signal controller which controls signals which drive the display panel; and
a common voltage generator which selectively applies first common voltage or second common voltage to the display panel,
wherein the common voltage generator includes:
a first common voltage generator which generates the first common voltage and applies the first common voltage to the display panel;
a second common voltage generator which generates the second common voltage and applies the second common voltage to the display panel; and
a common voltage controller which selectively applies the first common voltage or the second common voltage to the display panel,
wherein the first common voltage and the second common voltage have different values.

8. The display device of claim 7, wherein
the common voltage controller controls
the first common voltage generator to apply the first common voltage to the display panel during a first period, and the second common voltage generator to apply the second common voltage, to the display panel during a second period,
the first period and the second period each correspond to predetermined time intervals, and
the first period and the second period alternately repeat.

9. The display device of claim 8, wherein
the first period corresponds to a time interval of one second or more, and
the second period corresponds to a time interval of one frame or more.

10. The display device of claim 7, wherein
the display panel includes
a first substrate and a second substrate which face each other;
a first field generating electrode and a second field generating electrode which are on the first substrate; and
a liquid crystal layer which is between the first substrate and the second substrate, and
the liquid crystal layer is driven by an electric field which is generated between the first field generating electrode and the second field generating electrode.

11. The display device of claim 7, wherein
the common voltage controller
controls the first common voltage generator to apply the first common voltage to the display panel when an average gray of the input image data of one frame is lower than a first gray, and
controls the second common voltage generator to apply the second common voltage to the display panel when the average gray of the input image data of one frame is equal to or higher than the first gray.

12. The display device of claim 7, wherein:
the input image data includes first color input image data, second color input image data and third color input image data, and
the common voltage controller
controls the first common voltage generator to apply the first common voltage to the display panel when all of an average gray of the first color input image data, an average gray of the second color input image data, and an average gray of the third color input image data in one frame are lower than a second gray, and
controls the second common voltage generator to apply the second common voltage to the display panel when one or more of the average gray of the first color input image data, the average gray of the second color input image data, and the average gray of the third color input image data in one frame are equal to or higher than the second gray.

13. A driving method of a display device, the driving method comprising:
generating first correction image data by performing accurate color capture correction on an input image data;
generating second correction image data by performing accurate color capture correction on the input image data; and
selectively outputting the first correction image data and the second correction image data, wherein
a maximum gray of the second correction image data is lower than a maximum gray of the first correction image data.

14. The driving method of a display device of claim 13, wherein
the first correction image data are generated and outputted during a first period, and the second correction image data are generated and outputted during a second period,
the first period and the second period each correspond to predetermined time intervals, and
the first period and the second period are alternately repeated.

15. The driving method of a display device of claim 13, wherein
the first correction image data are generated and outputted when an average gray of the input image data of one frame is lower than a first gray, and
the second correction image data are generated and outputted when the average gray of the input image data of one frame is equal to or higher than the first gray.

16. The driving method of a display device of claim 13, wherein
the input image data includes first color input image data, second color input image data and third color input image data,
the first correction image data are generated and outputted when all of an average gray of the first color input image data, an average gray of the second color input image data, and an average gray of the third color input image data in one frame are lower than a second gray, and
the second correction image data are generated and outputted when one or more of the average gray of the first color input image data, the average gray of the second color input image data, and the average gray of the third color input image data in one frame are equal to or higher than the second gray.

17. A driving method of a display device, the driving method comprising:
generating first common voltage;
generating second common voltage; and
selectively applying the first common voltage and the second common voltage to a display panel of the display device,
wherein the first common voltage and the second common voltage have different values.

18. The driving method of a display device of claim 17, wherein
the first common voltage is applied to the display panel during a first period, and the second common voltage is applied to the display panel during a second period, and
the first period and the second period each correspond to predetermined time intervals, and
the first period and the second period are alternately repeated.

19. The driving method of a display device of claim 17, wherein
the first common voltage is applied to the display panel when an average gray of the input image data of one frame is lower than a first gray, and
the second common voltage is applied to the display panel when the average gray of the input image data of one frame is equal to or higher than the first gray.

20. The driving method of a display device of claim 17, wherein
the input image data includes first color input image data, second color input image data and third color input image data, and
the first common voltage is applied to the display panel when all of an average gray of the first color input image data, an average gray of the second color input image data, and an average gray of the third color input image data in one frame are lower than a second gray, and
the second common voltage is applied to the display panel when one or more of the average gray of the first color input image data, the average gray of the second color input image data, and the average gray of the third color input image data in one frame are higher equal to or than the second gray.
